(19) United States
(12) Patent Application Publication
(10) Pub. No.: US 2006/0092519 A1
(43) Pub. Date: May 4, 2006

(54) Transparent substrate, electro-optical device, image forming device, and method for manufacturing electro-optical device

(75) Inventor: Hironori Hasei, Okaya (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/249,183

(22) Filed: Oct. 13, 2005

(30) Foreign Application Priority Data
Nov. 4, 2004 (JP) 2004-320149

(51) Int. Cl. G02B 27/10

(52) U.S. Cl. 359/618

(57) ABSTRACT

A transparent substrate including a micro lens, light entered a side of a light incident surface of the transparent substrate being emitted from the micro lens formed on a side of a light taking-out surface of the transparent substrate, the micro lens being provided in a groove concaved from the light taking-out surface, and the micro lens being provided with an optical surface continuing in one direction.

### TECHNICAL FIELD

The present invention relates to a transparent substrate, an electro-optical device, an image forming device, and a method for manufacturing the electro-optical device.

### RELATED ART

For image forming devices using an electro photographic method, exposure heads are used as an electro-optical device that exposures a photosensitive drum, which serves as an image carrier, so as to form a latent image. Recently, in order to make the exposure head thin and light, one is known that employs an organic electroluminescent element (organic EL element), which serves as a light-emitting element, as the light-emitting source of the exposure head.

In the exposure head equipped with the organic EL element (hereinafter, simply referred to as the organic EL exposure head), proposals to improve an efficiency of taking out light emitted from the organic EL element are developed in order to enhance the life span of the organic EL element. For example, it is cited in a first example of related art. In the first example of related art, a micro lens is formed integral with a surface for taking out the light emitted from an organic EL element, i.e. is formed integral with light taking-out surface. The surface is one side surface of a transparent substrate on which the organic EL element is formed. Accordingly, the light emitted from the organic EL element can be converged by the micro lens so as to be emitted. As a result, the efficiency of use of the light can be increased.

However, in the first example of related art, its refraction region of the micro lens is formed as follows: a region, which is the light taking-out surface and on which the micro lens is formed, is immersed into a mixed melted salt of potassium nitrate and the like; and then, an ion exchange is carried out to a transparent substrate (glass substrate). Because of this process, materials for forming the transparent substrate or the micro lens, and further, methods for manufacturing them are constrained. These constraints cause a problem of sacrificing the productivity of the organic EL exposure head.

Alternatively, proposals to expand a range of choice in forming materials and manufacturing methods are developed for the organic EL exposure head. For example, it is cited in a second example of related art. In the second example of related art, a circular hole is provided at the position at the side of the light taking-out surface, opposing to the organic EL element. Into the circular hole, a liquid (resin) is discharged by an inkjet method. Subsequently, the discharged resin is cured by irradiating ultraviolet rays or drying or the like. As a result, a micro lens is formed at the position opposing to the organic EL element. According to the second example of related art, the liquid can be employed as the material for forming the micro lens. Employing the liquid allows the range of choice in the materials for forming the organic EL exposure head and manufacturing method thereof to be expanded.

Japanese Unexamined Patent Publication 2000-77188 is the first example of related art. Japanese Unexamined Patent Publication 2003-19826 is the second example of related art.

However, in the second example of related art, the micro lens is formed by discharging a liquid into a circular hole having nearly the same size of the organic EL element, resulting in the following problems. If a discharge nozzle for discharging a liquid is displaced from the position located immediately above the circular hole, a given volume of the liquid for forming the micro lens cannot be discharged into the circular hole. The displacement results in variations in an opening diameter of micro lens or in refractive index, etc., causing a problem of sacrificing the productivity of the micro lens, and thus the productivity of the organic EL exposure head.

These problems may be remedied by enlarging the size of the circular hole. The enlarged hole, however, causes the displacement of the micro lens, arising the problem in that the efficiency of using light is lowered.

### SUMMARY

An advantage of the invention is to provide a transparent substrate, an electro-optical device, and an image forming device that are equipped with a micro lens having high productivity while maintaining an efficiency of using light, and to provide a method for manufacturing the electro-optical device.

A transparent substrate according to a first aspect of the invention includes a micro lens. Light entered a side of a light incident surface of the transparent substrate is emitted from the micro lens formed on a side of a light taking-out surface of the transparent substrate. The micro lens is provided in a groove concaved from the light taking-out surface, and is provided with an optical surface continuing in one direction.

According to the transparent substrate, the tolerance of the position for forming and allocating the micro lens can be expanded in the one direction by the optical surface, which is included in the micro lens, continuing in the one direction. As a result, the productivity of the micro lens, and thus the productivity of the transparent substrate can be improved. In addition, the micro lens can be formed adjacent to the light incident surface by the depth of the groove, allowing an opening angle of the micro lens with respect to the light incident surface to be increased. Therefore, the loss in the efficiency of using light irradiated on the surface including the one direction can be compensated with the efficiency of using light irradiated on the surface perpendicular to the one direction by forming the groove. As a result, the productivity of the transparent substrate, which maintains the efficiency of using light, can be improved.

In the transparent substrate, the one direction is a direction in which the groove is formed, and the micro lens is a half-cylindrical convex lens having the optical surface in the one direction.

According to the transparent substrate, the productivity of the transparent substrate can be improved while maintaining the efficiency of using light of the transparent substrate by forming the half-cylindrical convex lens having the optical surface in the direction in which the groove is formed.

In the transparent substrate, the one direction is the direction in which the groove is formed. The micro lens is a half-cylindrical group convex lens including the half-cylindrical convex lens having the optical surface perpendicular to the one direction, and the half-cylindrical convex lens is provided in the one direction.

According to the transparent substrate, the productivity of the transparent substrate can be improved while maintaining the efficiency of using light of the transparent substrate by forming the half-cylindrical group convex lens having the optical surface in the direction perpendicular to the direction in which the groove is formed.

An electro-optical device according to a second aspect of the invention includes a micro lens and a transparent substrate. Light emitted from a light-emitting element arranged in one direction on a light-emitting element forming surface of the transparent substrate is emitted from the micro lens formed on a side of a light taking-out surface of the transparent substrate, the light taking-out surface opposing to the light-emitting element forming surface. The micro lens is provided in a groove concaved from the light taking-out surface. The micro lens has an optical surface opposing to the light-emitting element and continuing in one direction.

According to the electro-optical device, the tolerance of the position for forming and allocating the micro lens can be expanded in one direction by the optical surface, which is included in the micro lens, continuing in the one direction. As a result, the productivity of the micro lens and thus the productivity of the electro-optical device can be improved. In addition, the micro lens can be formed adjacent to the light-emitting element by the depth of the groove, allowing an opening angle of the micro lens with respect to the light-emitting element to be increased. Therefore, the loss in the efficiency using light irradiated on the surface including the one direction can be compensated with the efficiency using light irradiated on the surface perpendicular to the one direction by forming the groove. As a result, the productivity of the electro-optical device, which maintains the efficiency of using light, can be improved.

In the electro-optical device, the light-emitting element is an electroluminescent element including: a transparent electrode formed on a side of the light taking-out surface; a backside electrode formed so as to oppose to the transparent electrode; and a light-emitting layer formed between the transparent electrode and the backside electrode.

According to the electro-optical device, the efficiency of using light of the electro-optical device including the electroluminescent element is compensated, allowing its productivity to be improved.

In the electro-optical device, the light-emitting layer is formed with the organic material, while the electroluminescent element is the organic electro luminescent element.

According to the electro-optical device, the efficiency of using light of the electro-optical device including the organic electroluminescent element is maintained, allowing its productivity to be improved.

In the electro-optical device, the one direction is a direction in which the groove is formed, and the micro lens is a half-cylindrical convex lens having the optical surface in the one direction.

According to the electro-optical device, the productivity of the electro-optical device can be improved while maintaining the efficiency of using light of the electro-optical device by forming the half-cylindrical convex lens in the groove, the half-cylindrical convex lens having the optical surface in the direction in which the groove is formed.

In the electro-optical device, the one direction is a direction in which the groove is formed. The micro lens is a half-cylindrical convex group lens including the half-cylindrical convex lens having the optical surface perpendicular to the one direction, and the half-cylindrical convex lens is provided in the one direction.

According to the electro-optical device, the productivity of the electro-optical device can be improved while maintaining the efficiency of using light of the electro-optical device by forming the half-cylindrical group convex lens in the groove, the half-cylindrical group convex lens having the optical surface in the direction perpendicular to the direction in which the groove is formed.

An image forming device according to a third aspect of the invention includes: a charging unit charging an outer circumferential surface of an image carrier; an exposure unit exposing the charged outer circumferential surface of the image carrier so as to form a latent image; a development unit developing a developed image by supplying a colored particle to the latent image; and a transfer unit transferring the developed image to a transfer medium. The exposure unit is provided with the electro-optical device.

According to the image forming device, the exposure unit that exposes the charged image carrier is provided with the electro-optical device. As a result, the productivity of the image forming device can be improved while maintaining the efficiency of using light in the exposure of the image forming device.

A method for manufacturing an electro-optical device according to a fourth aspect of the invention includes: forming a groove to a light taking-out surface of a transparent substrate; forming a plurality of light-emitting elements at a position opposing to the groove, the position being located on a light-emitting element forming surface of the transparent substrate, the light-emitting element forming surface opposing to the light taking-out surface; discharging a liquid in the groove from a liquid discharging device; and solidifying the liquid so as to form a micro lens at a position opposing to the light-emitting element, the micro lens having an optical surface continuing in one direction.

According to the method for manufacturing an electro-optical device, the micro lens can be formed by solidifying the liquid discharged from the liquid discharging device. Therefore, the selection range of materials for forming the micro lens can be expanded. In addition, the tolerance of the position for forming and allocating the micro lens can be expanded in one direction by the optical surface, which is included in the micro lens, continuing in the one direction. As a result, the productivity of the micro lens and thus the productivity of the transparent substrate can be improved.

Further, the micro lens can be formed adjacent to the light-emitting element by the depth of the groove, allowing an opening angle of the micro lens with respect to the light-emitting element to be increased. Therefore, the loss in the efficiency of using light irradiated on the surface including the one direction can be compensated with the efficiency of using light irradiated on the surface perpendicular to the one direction by forming the groove. As a result, the productivity of the electro-optical device, which maintains the efficiency of using light, can be improved.

In the method for manufacturing an electro-optical device, the micro lens is a half-cylindrical lens having the optical surface. The optical surface is formed by forming a plurality of first droplets spaced apart each other in a forming direction in the groove, the first droplets being discharged by the liquid discharging device, and then by combining each of the first droplets with a second droplet discharged between the first droplets.

According to the method for manufacturing an electro-optical device, the droplets are formed in the groove so as to be spaced apart each other, and then the liquid is discharged again between the droplets, allowing the liquid to be prevented from being nonuniformly agglomerated. Therefore, the half-cylindrical convex lens manufactured by the liquid discharging device can be formed as the micro lens. As a result, the productivity of the electro-optical device can be improved while maintaining the efficiency of using light of the electro-optical device.

In the method for manufacturing an electro-optical device, the micro lens is a half-cylindrical group convex lens. The half-cylindrical group convex lens is formed by forming a plurality of half-cylindrical convex lenses so as to be spaced apart each other, the half-cylindrical convex lenses having the optical surface in a direction perpendicular to a direction in which the groove is formed, with a liquid discharged in the groove by the liquid discharging device, and then by discharging the liquid again between the half-cylindrical convex lenses.

According to the method for manufacturing an electro-optical device, after forming the plurality of half-cylindrical convex lenses so as to be spaced apart each other, the half-cylindrical convex lenses having the optical surface in a direction perpendicular to a direction in which the groove is formed, the liquid is discharged again between the half-cylindrical convex lenses, allowing the liquid to be prevented from being nonuniformly agglomerated. Therefore, the half-cylindrical group convex lens manufactured by the liquid discharging device can be formed as the micro lens. As a result, the productivity of the electro-optical device can be improved while maintaining the efficiency of using light of the electro-optical device.

### BRIEF DESCRIPTION OF THE DRAWINGS

The invention will be described with reference to the accompanying drawings, wherein like numbers refer to like elements, and wherein:

FIG. 1 is a schematic side sectional-view illustrating an image forming device according to a first embodiment of the invention;

FIG. 2 is a schematic plan view illustrating an exposure head according to the first embodiment of the invention;

FIG. 3 is a schematic front sectional-view illustrating the exposure head according to the first embodiment of the invention;

FIG. 4 is an enlarged side sectional-view illustrating the exposure head according to the first embodiment of the invention;

FIG. 5 shows a process of the exposure head according to the first embodiment of the invention;

FIG. 6 shows the process of the exposure head according to the first embodiment of the invention;

FIG. 7 shows the process of the exposure head according to the first embodiment of the invention;

FIG. 8 is a schematic plan view illustrating the exposure head according to a second embodiment of the invention;

FIG. 9 is a schematic plan view illustrating the exposure head according to the second embodiment of the invention;

FIG. 10 is a schematic front sectional-view illustrating the exposure head according to the second embodiment of the invention; and

FIG. 11 shows the process of the exposure head according to the second embodiment of the invention.

### DESCRIPTION OF THE EMBODIMENTS

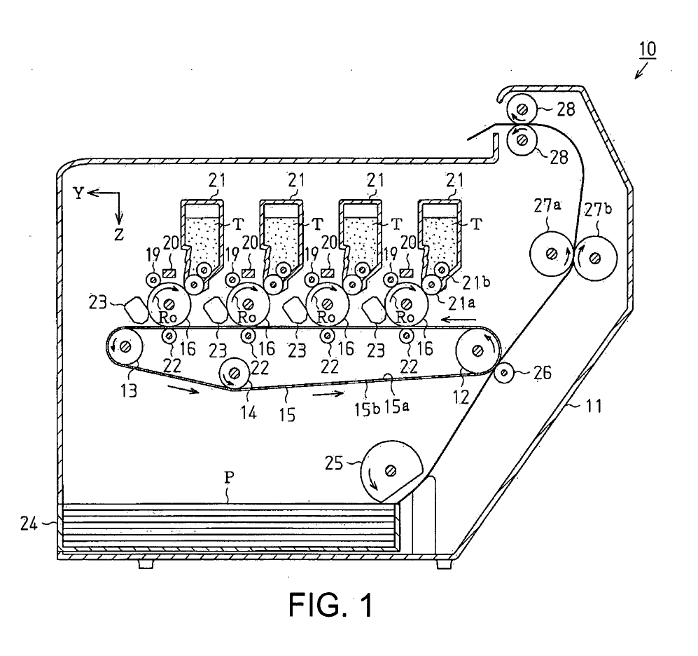

A first embodiment of the invention will be explained below with reference to FIGS. 1 to 7. FIG. 1 is a schematic side sectional view illustrating an electrophotographic printer serving as an image forming device.

### First Embodiment

As shown in FIG. 1, an electrophotographic printer 10 (hereinafter, simply referred to as the printer 10) is provided with a chassis 11 formed in a box shape. Inside the chassis 11, a driver roller 12, a driven roller 13, and a tension roller 14 are provided. In addition, an intermediate transfer belt 15, which serves as a transfer medium, is stretched with respect to each of the rollers 12 to 14. The intermediate transfer belt 15 is circularly driven by the rotation of the driver roller 12 in the direction indicated by the arrow in FIG. 1.

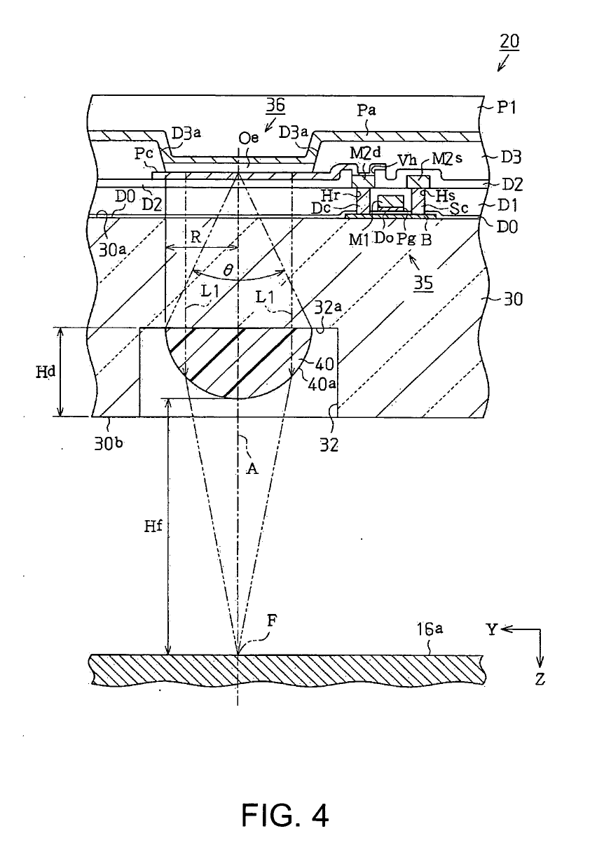

Above the intermediate transfer belt 15, four (4) photosensitive drums 16, which serve as an image carrier, are rotatably provided side-by-side in the stretched direction of the intermediate transfer belt 15 (in a sub scanning direction Y). On the outer circumferential surface of the photosensitive drum 16, a photosensitive layer 16a (refer to FIG. 4) having photoconductivity is formed. The photosensitive layer 16a is charged with plus or minus charge in a dark area. The charge is disappeared from a part on which if light having a given wavelength range is irradiated. Accordingly, the electrophotographic printer 10, which is configured with four photosensitive drums 16, is a tandem type printer.

Around each photosensitive drum 16, each charging roller 19 serving as a charging unit, each organic electroluminescent array exposure head 20 (hereinafter, simply referred to as the exposure head 20) serving as an electro-optical device included in an exposure unit, each toner cartridge 21 serving as a development unit, each first transfer roller 22 included in a transfer unit, and each cleaning unit 23 are provided.

The charging roller 19, which is a rubber roller having semiconductivity, closely contacts to the photosensitive drum 16. Upon rotating the photosensitive drum 16 while a direct voltage is applied to the charging roller 19, the whole circumferential surface of the photosensitive layer 16a of the photosensitive drum 16 is charged at a given charged potential.

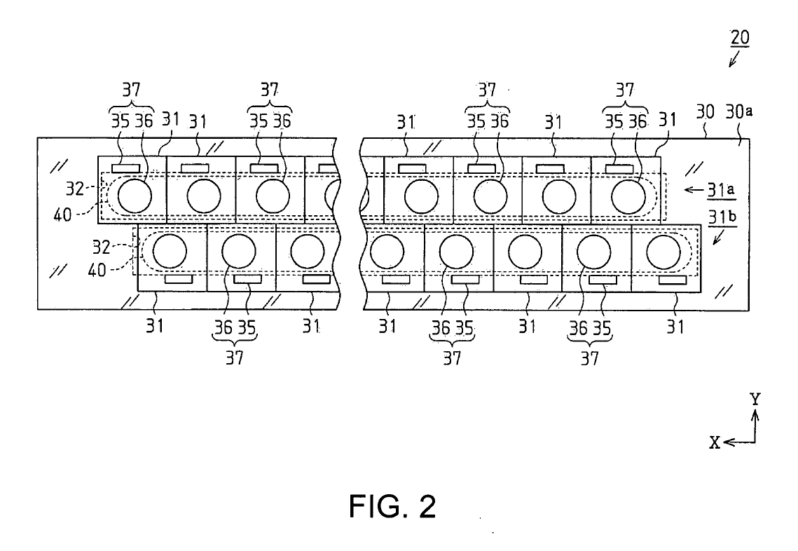

The exposure head 20, which is a light source emitting light having a given wavelength range, is formed like a long plate shape as shown in FIG. 2. The exposure head 20 is positioned at the position apart from the photosensitive layer 16a with a given distance so that its longitudinal direction is in parallel with the axial direction of the photosensitive drum 16 (direction perpendicular to FIG. 1: main scanning direction X). If the exposure head 20 emits the light, which is based on printing data, in the vertical direction Z (refer to FIG. 1) while the photosensitive drum 16 rotates in a rotation direction Ro, the outer circumferential surface of the photosensitive layer 16a is exposed by the light having a given wavelength range. As a result, in the photosensitive layer 16a, charges at the exposed part (exposed spot) are disappeared so that an electrostatic image (electrostatic latent image) is formed on its outer circumferential surface. Incidentally, the wavelength range of the light emitted from the exposure head 20 for exposing is matched with the spectral sensitivity of the photosensitive layer 16a. That is, the peak wavelength of emitted energy of the light emitted from the exposure head 20 for exposing nearly coincides with the peak wavelength of the spectral sensitivity of the photosensitive layer 16a.

The toner cartridge 21 is formed like a box shape, in which a toner T serving as a colored particle having a diameter of approximately 10 μm is stored. In four (4) toner cartridges 21 in the embodiment, the toner T of four (4) colors (black, cyan, magenta, and yellow) is correspondingly stored in the toner cartridges 21. The toner cartridge 21 is equipped with a development roller 21a and supply roller 21b in this order from the photosensitive drum 16. The rotation of the supply roller 21b carries the toner T to the development roller 21a. The development roller 21a charges the toner T carried by the supply roller 21b by friction it with the supply roller 21b so that the charged toner T uniformly adheres on the outer circumferential surface of the development roller 21a.

Then, the supply roller 21b and the development roller 21a are rotated while the bias potential, which has an opposite potential to that of the charged potential, is applied to the photosensitive drum 16. Accordingly, the photosensitive drum 16 causes electrostatic adsorption power, which corresponds to the bias potential, between the exposed spot and the development roller 21a (toner T). The electrostatic adsorption power moves the toner T that adheres on the outer circumferential surface of the development roller 21c to the exposed spot of the photosensitive drum 16 so as to be adsorbed. Accordingly, on the outer circumferential surface of each photosensitive drum 16 (each photosensitive layer 16a), a visible image (developed image) having a single color is formed (developed) corresponding to each electrostatic latent image.

Each first transfer roller 22 is provided at the position that opposes to each photosensitive drum 16 and located on an internal surface 15a of the intermediate transfer belt 15. The first transfer roller 22, which is a conductive roller, rotates so that its outside circumferential surface closely contacts on the internal surface 15a of the intermediate transfer belt 15. When rotating the photosensitive drum 16 and the intermediate transfer belt 15 by applying a direct voltage to the first transfer roller 22, the toner T adsorbed on the photosensitive layer 16a is sequentially transferred and adsorbed to an outer surface 15b of the intermediate transfer belt 15 by the electrostatic adsorption power acting toward the first transfer roller 22. Accordingly, the first transfer roller 22 firstly transfers the developed image formed on the photosensitive drum 16 to the outer surface 15b of the intermediate transfer belt 15. The first transfer of the developed image with a single color is repeated four times by each photosensitive drum 16 and the first transfer roller 22. As a result, a full color image (toner image) is achieved on the outer surface 15b of the intermediate transfer belt 15 by superposing these developed images.

The cleaning unit 23, which is equipped with a light source (not shown) such as LED or the like and a rubber blade, neutralizes the photosensitive layer 16a that has been charged by irradiating light to the photosensitive layer 16a after the first transfer. The cleaning unit 23 mechanically removes the toner T, which remains on the photosensitive layer 16a that has been neutralized, with the rubber blade.

Below the intermediate transfer belt 15, a recoding paper cassette 24 storing recoding paper P is provided. Above the recoding paper cassette 24, a paper-feeding roller 25 is provided that feeds the recoding paper P for the intermediate transfer belt 15. At the position that is located above the paper feeding roller 25 and faces to the driver roller 12, a second transfer roller 26 is provided that is included in the transfer unit. The second transfer roller 26 is a conductive roller such as the first transfer roller 22, presses the backside of the recording paper P and makes the surface of the paper contact the outer side 15b of the intermediate transfer roller 15. When rotating the intermediate transfer roller 15 by applying a direct voltage to the second transfer roller 26, the toner T adsorbed to the outer side 15b of the intermediate transfer roller 15, is moved to the surface of the recording paper P and adsorbed to it. Namely, toner images formed on the outer side 15b of the intermediate transfer roller 15, are secondly transferred to the surface of the paper P by the second transfer roller 26.

A heat roller 27a including a heat source and a pressure roller 27b pressing the roller 27a are installed above the second transfer roller 26. Then, after secondary transfer, the recording paper P is moved to the location between the heat roller 27a and the pressure roller 27b, softening the toner T transferred to the paper P by heating and solidifying it after interfused into the recording paper P. Accordingly, toner images are fixed on the surface of the recording paper P. The recoding paper P on which toner are fixed, is sent out from the chassis 11 by a sending out roller 28.

Therefore, the printer 10 exposes the charged photosensitive layer 16a by the exposure head 20 and forms an electrostatic latent image in the photosensitive layer 16a. Next, the printer 10 forms a single-colored developed image in the photosensitive layer 16a by developing the electrostatic latent image in the photosensitive layer 16a. Further, the printer 10 firstly transfers the developed image in the photosensitive layer 16a into the surface of the intermediate transfer belt 15 and forms a full color toner image on the intermediate transfer belt 15. Finally, the printer 10 completes printing by secondarily transferring the toner image on the intermediate transfer belt 15 onto the recoding paper P and fixing the toner image by adding heat and pressure.

Next, the detail of the exposure head 20 serving as the electro-optical device will be explained referring to FIGS. 2 to 4. FIGS. 2 to 4 are a plan view, a front cross-sectional view and a side cross-sectional view illustrating the exposure head 20 respectively.

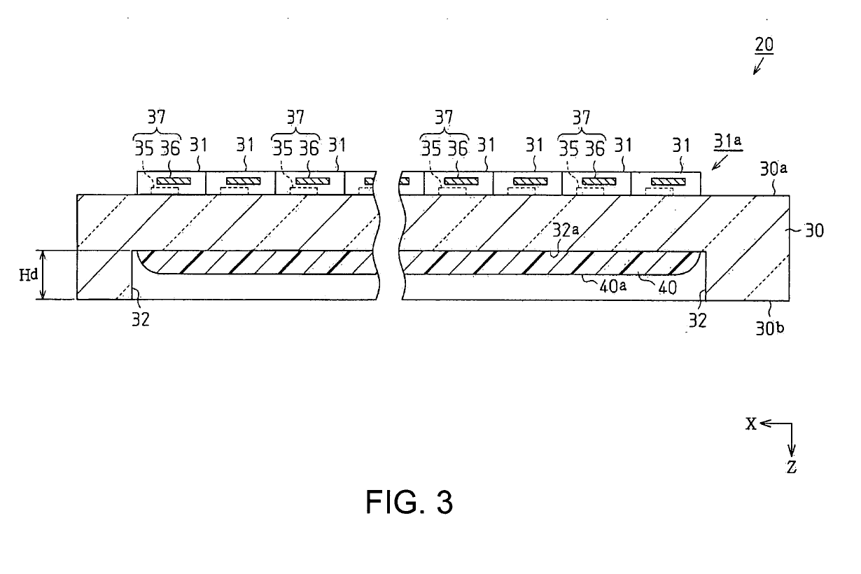

As shown in FIG. 2, the exposure head 20 is provided with a glass substrate 30 as a transparent substrate. The glass substrate 30 is a long substrate of which a width in longitudinal direction (the main scanning direction X) is almost the same of a width of an axis of the photosensitive drum 16. Further, in the embodiment, the glass substrate 30 includes an upper surface 30a for forming a light-emitting element as a light incident surface (the opposite surface to the photosensitive drum 16) and a bottom surface 30b for taking out light (the surface toward the photosensitive drum 16) as shown in FIG. 3.

First, the surface 30a for forming a light-emitting element will be explained below. As shown in FIG. 2, the surface 30a for forming a light-emitting element of the glass substrate 30 is provided with many of regions 31 for forming pixels, which are arranged in two columns toward the longitudinal direction (the main scanning direction X). Here, in the embodiment, these two columns of regions 31 for forming pixels include a first pixel column 31a, which is an upper column in FIG. 2 and a second pixel column 31b, which is a lower column in FIG. 2.

Each of regions 31 for forming pixels includes a pixel 37, which has a thin film transistor (TFT) 35 (hereinafter, simply referred to as TFT 35) and a light-emitting element 36. The TFT 35 is turned on by a data signal generated by printing data and makes the light-emitting element 36 emit.

As shown in FIG. 4, the TFT 35 is provided with a channel film B in the bottom layer. The channel film B is an island like p-type polysilicon film formed on the surface 30a for forming a light-emitting element and provided with activated n-type region (source and drain regions) on both left and right regions in FIG. 4. Namely, the TFT35 is a polysilicon TFT.

In the center of upper side of the channel film B, a gate insulation film D0, a gate electrode Pg and a gate wiring M1 are formed in order from the surface 30a for forming a light-emitting element. The gate insulation film D0 is an insulation film, which is transparent to light like a silicon oxide, and deposited on almost all the surface 30a for forming a light-emitting element. The gate electrode Pg is made of low resistive metal such as tantalum and located in the almost center of the channel film B. The gate wiring M1 is a transparent conductive film such as ITO, which is transparent to light, and electrically connects the gate electrode Pg to a data wiring drive circuit not shown in the figure. When the data wiring drive circuit inputs a data signal to the gate electrode Pg via the gate wiring M1, the TFT 35 is turned on based on the signal.

A source contact Sc and a drain contact Dc, which extend upward along the vertical direction Z and are located within the channel film B, are formed on an upper side of the source region and drain region. Each of contacts Sc and Dc is made of metal silicide lowering contact resistance to the channel film B. Then, each of contacts Sc and Dc, and the gate electrode Pg (gate wiring M1) are electrically insulated from a first interlayer insulation film D1 made of silicon oxide or the like.

A power source line M2s and anode line M2d, made of low resistive metal like aluminum, are formed on the upper side of each of contacts Sc and Dc. The power source line M2s electrically connects the source contact Sc to a power source for drive, which is not shown. The anode line M2d electrically connects the drain contact Dc to the light-emitting element 36. The power source line M2s and anode line M2d are electrically insulated from a second interlayer insulation film D2 made of silicon oxide or the like. Then, the TFT35 is turned on based on a data signal, supplying a drive current corresponding to the data signal to the anode line M2d (the light-emitting element 36) from the power source line M2s (the power source for drive).

As shown in FIG. 4, the light-emitting element 36 is formed on the second interlayer insulation film D2. An anode electrode Pc, which is a transparent electrode, is formed as the bottom layer of the light-emitting element 36. The anode electrode Pc, which is a transparent conductive film such as ITO, is connected to the anode line M2d. A third interlayer insulation film D3 is deposited to the outer circumferential surface of the anode electrode Pc, surrounding the anode electrode Pc. The third interlayer insulation film D3 is made of resin such as a photosensitive polyimide or acrylic and electrically insulates the anode electrode Pc of the light-emitting element 36. The third interlayer insulation film D3 opens the upper side of the anode Pc with a circular shape and is provided with an inner circumferential surface as a bulkhead D3a. The inside radius of the bulkhead D3a at the side of the anode Pc is arranged by the adjustment radius R.

An organic electroluminescent layer (organic EL layer) Oe made of organic material is formed on the anode electrode Pc and inside of the bulkhead D3a. The organic electroluminescent layer Oe is an organic chemical layer including double layers such as a hole transport layer and a light-emitting layer. Further, a cathode electrode Pa, made of metal such as aluminum having light reflection property, is formed as a backside electrode on the upper surface of the organic electroluminescent layer Oe. The cathode electrode Pa covers over all the surface 30a for forming a light-emitting element and are commonly hold by each pixel 37, supplying a potential, which is common for each of light-emitting elements 36.

Namely, the light-emitting element 36 is an organic electroluminescent element (an organic EL element) provided with the anode electrode Pc, the organic electroluminescent layer Oe and the cathode Pa. The inner radius of the emitting surface (the organic EL element layer Oe) consists of the adjustment radius R.

A sealing part P1 is formed on the upper surface of the cathode Pa. The sealing part P1 is made of a coating material such as resin, preventing a metal layer and the organic EL layer Oe from being oxidized.

Then, a driving current corresponding to data signal is applied to the anode line M2d, making the organic EL layer Oe emit light having a luminance corresponding to the driving current. In this time, light emitted to the cathode electrode Pa (upper side in FIG. 4) from the organic EL layer Oe is reflected at the electrode Pa. Hence, most of the light emitted from the organic EL layer Oe is irradiated onto the surface 30b for taking out light (the side of the photo sensitive drum 16) via the anode Pc, the second interlayer insulation film D2, the first interlayer insulation film D1, the gate insulation film D0 and the glass substrate 30.

Next, the surface 30b for taking out light of the glass substrate 30 is explained. As shown in FIG. 3, the surface 30b opposing to the surface 30a of the glass substrate 30 is provided with two columns grooves 32 (dot lines in FIG. 2) opposing to each of pixel columns 31a and 31b. The width of the longitudinal direction (the width in the main scanning direction X) of the groove 32 is the almost same of the width of each of pixel columns 31a and 31b in the main scanning direction X. Further, the groove 32 is formed as shown in FIG. 4 so that the width in the horizontal direction (the width in the sub scanning direction Y) is slightly wider than the diameter of the organic EL layer Oe and its depth is the distance Hd.

As shown in FIG. 4, a micro lens 40 is formed on a groove bottom 32a of the groove 32. The micro lens 40 is a half-cylindrical convex lens, which is sufficiently transparent to the wavelength of light emitted from the organic EL layer Oe, and has an outer circumferential surface (a light-emitting surface 40a as an optical surface), of which direction is perpendicular to FIG. 4 (in the main scanning direction X). The micro lens 40 is formed toward the direction of the width (the main scanning direction X) along the each of pixel columns 31a and 31b shown as the dot line in FIG. 2 and has an optical axis A along the vertical direction Z as shown in FIG. 4. Further, the micro lens 40 is continuously located at the position opposing to each of the light-emitting elements 36 (the organic EL layer Oe). It's curvature radius is the almost same of the inside radius of the organic EL layer Oe, namely the adjustment radius R. The micro lenses 40 forms an image from the light-emitting surface 40a by reflecting power corresponding to its curvature radius.

Then, the micro lens 40 having a half-cylindrical shape converges light emitted from the light-emitting element 36 by reflecting light irradiated onto the surface perpendicular to the main scanning direction X. On the other hand, the micro lens 40 emits light irradiated onto the surface perpendicular to the sub scanning direction Y without converging (utilizing) the light.

Further, as shown in FIG. 4, the micro lens 40 is formed within the groove 32, making the light-emitting surface 40a being near to the organic EL layer Oe side from the surface 30b for taking out light by the near distance Hd. Accordingly, the angle formed toward the diameter of the micro lens 40 from the organic EL layer Oe on the optical axis A (the opening angle θ) is increased by the near distance Hd comparing to the opening angle when the micro lens 40 is formed on the surface 30b for taking out light. Namely, in the micro lens 40, the capability of converging light on the light-emitting surface 40a, i.e. the efficiency of using light emitted from the light-emitting element 36, is increased by the opening angle θ.

Hence, the micro lens 40 increases the efficiency of using light irradiated onto the surface perpendicular to the main scanning direction X (the direction for forming the groove 32), compensating the loss of using light irradiated onto the surface perpendicular to the sub scanning direction Y. Therefore, it is possible to expand the tolerance for forming and allocating the micro lens 40 toward the main scanning direction X thereby, comparing to a case when a lens of which size is almost the same as that of the light-emitting element 36 is located at the position opposing to the light-emitting element 36.

Here, in the embodiment, as shown in FIG. 4, the micro lens 40 is located so that the distance between the top of the light-emitting surface 40a and the photo sensitive layer 16a becomes the focal point distance Hf on image side of the micro lens 40. Namely, the micro lens 40 should be located so that the cross point between the optical axis A and the pass of light (parallel light bundle L1) emitted from the organic EL layer Oe along the optical axis A is located on the photosensitive layer 16a. This cross point is the focal point F on image side. Thus, the desired exposed spot size of the light emitted from the micro lens 40 is formed on the photosensitive layer 16a thereby.

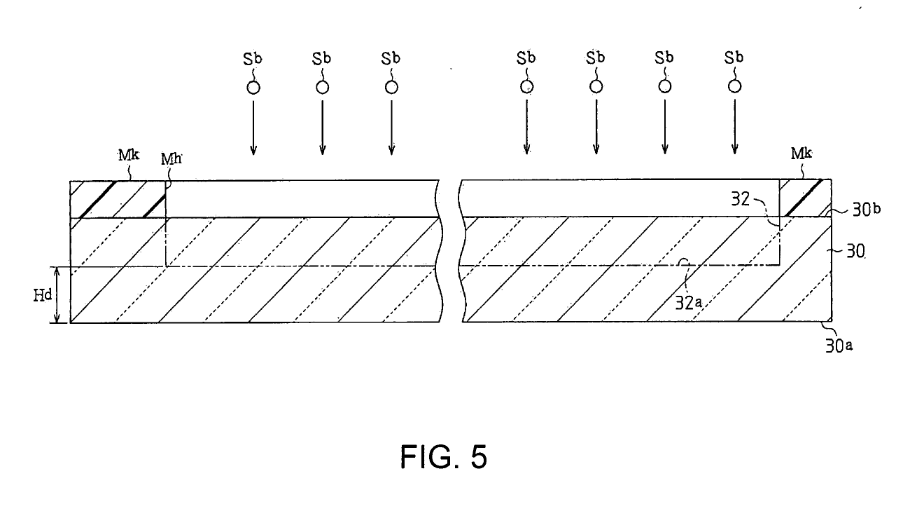

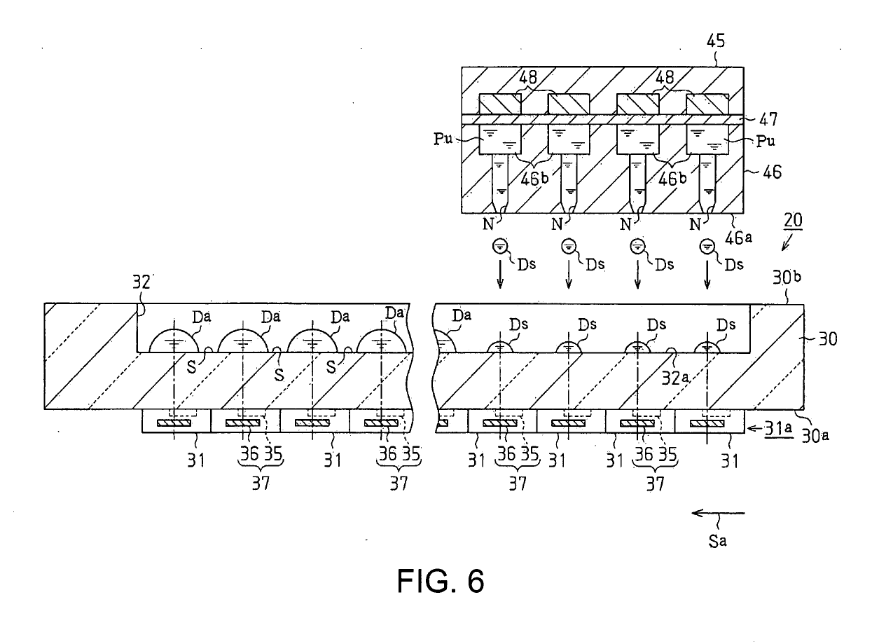

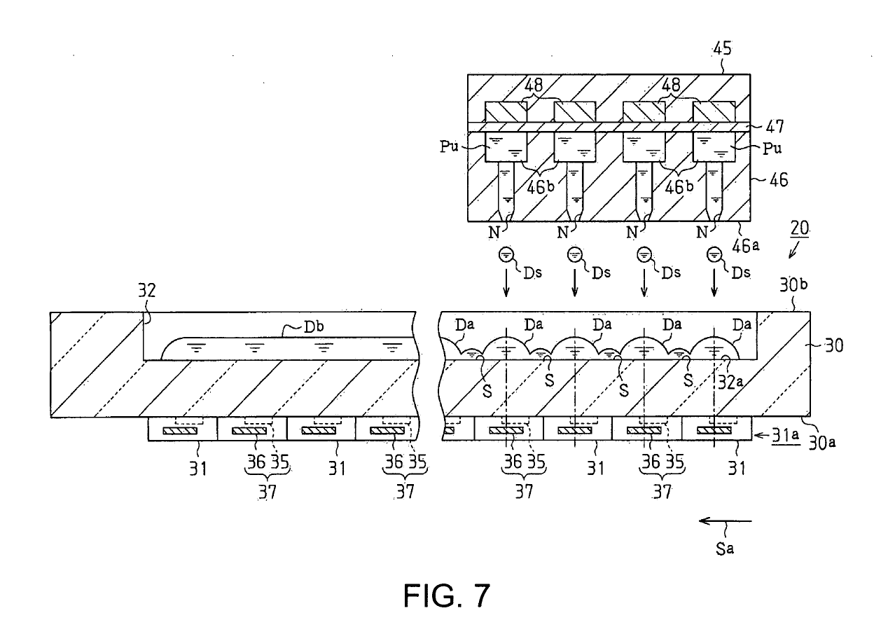

Next, a method for manufacturing the exposure head 20 will be explained referring to FIG. 5 to FIG. 7. FIG. 5 shows a process for forming the groove 32. FIGS. 6 and 7 show a process for forming micro lenses 40.

First, a mask agent Mk for sandblasting is coated on the all surface 30b for taking out light of the glass substrate 30, then, rectangular hole Mh, of which size is the groove 32, is patterned in the mask agent Mk as shown in FIG. 5. Next, sand Sb such as inorganic oxide is sprayed onto the surface 30b for taking out light by a well-known sandblast device, chipping off the surface 30b for taking out light (the glass substrate 30) within the rectangular hole Mh by the predetermined depth (the near distance Hd) and removing the mask agent Mk from the surface 30b for taking out light thereafter. The groove 32 having it's depth; the nearest distance Hd, is formed (chain double dashed line in FIG. 5) thereby. A fluorine resin dispersed liquid is injected into the groove 32 after forming the groove 32 so as to adhere within the circumferential surface of the groove 32, planarizing the groove bottom 32a and performing a liquid repellent finish against UV cured resin Pu within the groove 32, explained later.

The pixel 37 is formed on the surface 30a for forming a light-emitting element after forming the groove 32 in the surface 30b for taking out light. A method for forming the pixel 37 is explained referring to FIG. 4. An amorphous silicon layer is deposited on the all surface 30a for forming a light-emitting element by chemical vapor deposition using disilane as a material gas. Next, UV light is irradiated onto the deposited amorphous silicon film by an excimer laser or the like, forming a polysilicon film on the all surface 30a for forming a light-emitting element. Then, the polysilicon film is patterned by a photolithography or etching or the like, forming the channel film B as shown in FIG. 4.

After forming the channel film B, a silicon oxide layer or the like is deposited on the channel film B and the surface 30a for forming a light-emitting element, forming the gate insulation layer D0. Further, after forming the gate insulation layer D0, a low resistive metal film such as tantalum is deposited on the upper surface of the gate insulation layer D0 by sputtering and patterned, forming the gate electrode Pg on the upper surface of the gate insulation layer D0. Then, after forming the gate electrode Pg, an n-type region (a source and drain regions) is formed in the channel film B by ion doping with the gate electrode Pg as a mask. Then, a transparent conductive film such as ITO is deposited on the all surface of the gate electrode Pg and the gate insulation film D0 by sputtering or the like and patterned, forming the gate wiring M1 on the gate electrode Pg.

After forming the gate wiring M1, a silicon oxide or the like is deposited on the all surfaces of the gate wiring M1 and the gate insulation film D0 by chemical vapor deposition with tetraethoxysilane (TEOS) as a material gas, forming the first interlayer insulation film D1. Further, after forming the first interlayer insulation film D1, a pair of circular holes (contact holes Hr and Hs) is formed, as opening the insulation film D1 from the source and drain regions to the upper side along the vertical direction Z. Next, a metal film is deposited on the upper surface of the first interlayer insulation film D1 with embedding metal silicide or the like within the contact holes Hr and Hs by sputtering. Then, the metal film is removed by etching except the regions of contact holes Hr and Hs, forming the source contact Sc and the drain contact Dc.

After forming contacts Sc and Dc, metal film such as aluminum is deposited over the surface of the contacts Sc and Dc, and the first interlayer insulation film D1 and patterned, forming the power source line M2s and the anode line M2d, which are connected to contacts Sc and Dc. Next, a silicon oxide layer or the like is deposited on the all surfaces of the power source line M2s, the anode line M2d and the first interlayer insulation film D1 by chemical vapor deposition with TEOS as a material gas. Subsequently, a circular hole (a via hall Hv) is formed by photolithography or etching and opened from a part of the anode line M2d to the top of the second interlayer insulation film D2 along the vertical direction Z. After forming the via hall Hv, a transparent conductive film having light transparence property such as ITO is deposited on the all surface of the second interlayer insulation film D2 with embedding it into the via hall by sputtering. Then, the transparent conductive film is patterned, forming the anode Pc connecting the anode line M2d via the hall Hv around the position opposing to the groove 32 as shown in FIG. 4.

Further, after forming the anode electrode Pc, a mask such as a photo resist is formed in a position on the anode electrode Pc opposing to the groove 32, and resin film such as a photosensitive polyimide or acryl is deposited on the all surfaces of the anode electrode Pc and the second interlayer insulation film D2. Then, the photo resist is removed, forming the third interlayer insulation film D3 provided with the bulkhead D3a having the adjustment radius R.

After forming the third interlayer insulation film D3, a material for forming a hole transport layer is discharged to the surface of the anode Pc surrounded by the bulkhead D3a by an inkjet method, dried and solidified, as forming a hole transport layer. Further, a material for forming a light-emitting layer is discharged to the surface of the hole transport layer by an inkjet method, dried and solidified, as forming a light-emitting layer. Then, the organic EL layer Oe including a hole transporting layer and a light-emitting layer is formed so that the inner radius becomes the adjustment radius R.

After forming the organic EL layer Oe, a metal film such as aluminum is deposited on the all surfaces of the organic EL layer Oe and the third interlayer insulation film D3 by sputtering, forming the cathode electrode Pa. Further after forming the anode electrode Pa, a coating material such as resin is deposited on the all surface of the anode electrode Pa by chemical vapor deposition, forming the sealing part P1. Hence, the pixel 37 including the light-emitting element 36 opposing to the groove 32 is formed on the surface 30a for forming a light-emitting element.

The micro lens 40 is formed within the groove 32 after forming the pixel 37. First, the liquid discharging device for forming the micro lens 40 is explained. As shown in FIG. 6, a liquid discharging head 45 of the liquid discharging device is positioned above the surface 30b for taking out light. The liquid discharging head 45 is provided with a nozzle plate 46. Many of nozzles N are arranged on the one side of the nozzle plate 46 (the surface 46a for forming a nozzle), which faces the surface 30b for taking out light, along the main scanning direction X, namely an arrow direction Sa in FIG. 6. This nozzles discharge UV cured resin Pu (hereinafter, simply referred to as resin Pu) as a liquid. The arranging pitch of the nozzles N is equal to that of the light-emitting element 36. Here, in the liquid discharging device of the embodiment, the glass substrate 30 is placed on a substrate stage, which is not shown, so that the surface 30b for taking out light is in parallel with the surface 46a for forming a nozzle. In addition, in the liquid discharging device, the groove 32 is relatively transferred in the arrow direction Sa to the nozzles N by moving the substrate stage.

A supply chamber 46b, which can supply the resin Pu to inside each of the nozzles N by communicating a storage tank not shown, is formed on each of the nozzles N. On each supply chamber 46b, a vibrating plate 47 is provided that increases and decreases the volume inside the supply chamber 46b by oscillating in the vertical direction in FIG. 6. A piezoelectric element 48, which vibrates the vibration plate 47 with an expanding-contracting movement in the vertical direction in FIG. 6, is respectively disposed at the position, which is located on the vibration plate 47, opposing to the supply chamber 46b.

Next, the method for manufacturing the micro lens 40 with the liquid discharging device will be explained. First, a driving signal for forming the micro lens 40 is input to the liquid discharging head 45. The substrate stage moves with the glass substrate 30 so as to position the left end part of the groove 32, which opposes to the first pixel column 31a, in FIG. 6, directly under the liquid discharging head 45 (the nozzles N). Upon positioning the left end part of the groove 32 directly under the nozzle N, the groove 32 (the glass substrate 30) is moved in the arrow direction Sa by the substrate stage. When the center position of each light-emitting element 36 (organic EL layer Oe) reaches at the position directly under the nozzle N corresponding to each light-emitting element 36, the volume of the supply chamber 46b in the liquid discharging device 45 increases and decreases with the expanding-contracting movement of the piezoelectric element 48 based on the input driving signal. In this time, when the volume of the supply chamber 46b is decreased, the resin Pu corresponding to the decreased volume is discharged into the groove 32 as a micro droplet Ds. Subsequently, when the volume of the supply chamber 46b is increased, the resin Pu corresponding to the increased volume is discharged inside the supply chamber 46 from the storage tank not shown. The liquid discharging head 45 repeats increasing and decreasing the volume of the supply chamber 46b predetermined times so as to discharge the micro droplet Ds on the position, which is located in the groove 32, opposing to the light-emitting element 36, forming a droplet Da.

The droplet Da formed in the groove 32 is agglomerated to a half-spherical shape by its surface tension and inner circumferential surface, which is made to exhibit liquid repellency, of the groove 32. The predetermined times to discharge the micro droplet Ds for forming the droplet Da is the number of times that satisfies the following conditions: the radius of the droplet Da becomes nearly equal to the adjustment radius R; and a clearance S is formed at outer circumference of the droplet Da so as not to be touched to adjacent droplet Da.

After forming the droplet Da toward the direction of the width along the first pixel column 31a, the left end side of the groove 32 is positioned again directly under the liquid discharging head 45 (the nozzle N) by moving the substrate stage. Upon positioning the left end part of the groove 32 directly under the nozzle N, the left end part of the groove 32 is moved in the arrow direction Sa by the substrate stage. Then, when each clearance S reaches at the position directly under the nozzles N corresponding to each clearance S, the piezoelectric element 48 in the liquid discharging head 45 expands and contracts so as to discharge the micro droplet Ds to the clearance S as shown in FIG. 7. In this time, the droplet Da, which has been formed in the groove 32 in advance, increases its viscosity by evaporating its solvent components during the transfer of the substrate stage. Therefore, each droplet Da combines the micro droplet Ds discharged to the clearance S while keeping its formed position, forming a droplet Db having a half-cylindrical shape continuing toward the direction of the width along the first pixel column 31a as shown in FIG. 7.

Likewise, the droplet Db is formed in the groove 32 opposing to the second pixel column 31b.

After forming the droplet Db in each grove 32 toward the direction of the width along each of the pixel columns 31a and 31b, each droplet Db is cured by irradiating ultra violet rays toward inside each groove 32. Accordingly, a half-cylindrical convex lens (the micro lens 40), which is formed so that each curvature radius is nearly the same of the adjustment radius R, is manufactured at the position opposing to the light-emitting element 36 of each of pixel columns 31a and 31b.

Next, effects of the first embodiment will be described below.

(1) In the embodiment, the groove 32 is formed on the surface 30b for taking out light of the glass substrate 30 and the micro lens having a half-cylindrical shape is formed along the arranging direction of the light-emitting element 36 (the direction of the main scanning X) in the groove 32. Therefore, it is possible to expand the tolerance for forming and allocating the micro lens 40 toward the main scanning direction X thereby, comparing to a case when a lens of which size is almost the same as that of the light-emitting element 36 is located at the position opposing to the light-emitting element 36. As a result, the productivity of the micro lens 40 and thus the productivity of the exposure head 20 and the printer 10 can be improved.

(2) In addition, the micro lens 40 (the light-emitting surface 40a) can be placed adjacent to the light-emitting element 36 by the depth of the groove 32 (the near distance Hd). Hence, the micro lens 40 can increase the efficiency of using light irradiated onto the surface perpendicular to the main scanning direction X, compensating the loss of using light irradiated onto the surface perpendicular to the sub scanning direction Y. Consequently, the productivity of the micro lens 40 and thus the productivity of the exposure head 20 and the printer 10 can be improved while maintaining the efficiency of using light emitted from the light-emitting element 36.

(3) Further, in the embodiment, the micro droplet Ds is discharged into the groove 32 so as to form the droplet Da with the clearance S. After forming the droplet Da, the micro droplet Ds is discharged to the clearance S. As a result, the droplet Db having a half-cylindrical shape can be formed without the resin Pu nonuniformly combined, forming the micro lens 40 having a half-cylindrical, which is the droplet Db.

(4) Moreover, since the tolerance for forming and allocating the micro lens 40 can be expanded toward the main scanning direction X, the tolerance of position shift of the nozzle N to the light-emitting element 36 can be expanded. As a result, the productivity of the micro lens 40 using the liquid discharging device and thus the productivity of the exposure head 20 and the printer 10 can be improved.

(5) In the embodiment, the light-emitting surface 40a of the micro lens 40 is formed in the groove 32 concaved from the surface 30b for taking out light. Accordingly, the micro lens 40 can be protected by the groove 32 (the surface 30b for taking out light). This allows the assembly of the glass substrate 30 to which the micro lens 40 has been formed to be easily done. As a result, the productivity of the exposure head 20 and the printer 10 can be improved.

(6) In the embodiment, the micro lens 40 is formed after forming the pixel element 37. Accordingly, the micro lens 40 can be free from contaminations or damages caused by the various kinds of materials used in forming the pixel element 37. As a result, the productivity of the micro lens 40 and thus the productivity of the exposure head 20 and the printer 10 can be improved.

### Second Embodiment

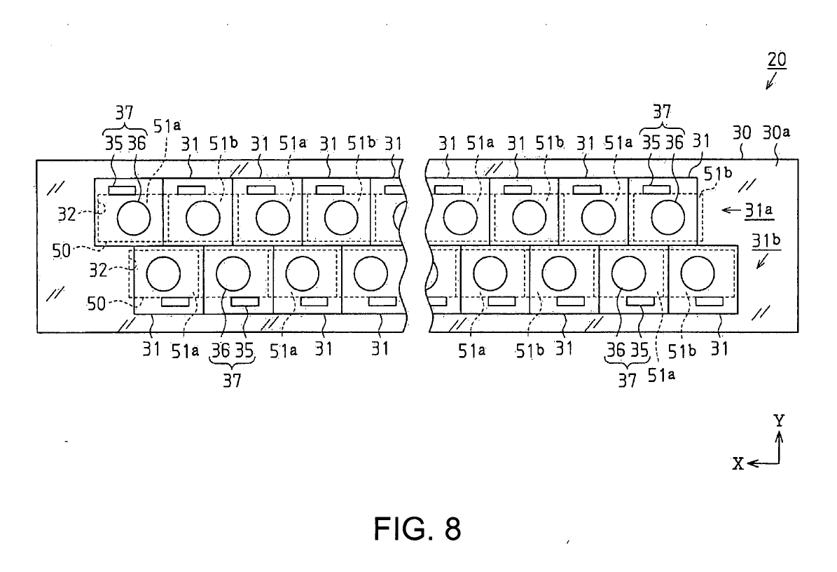

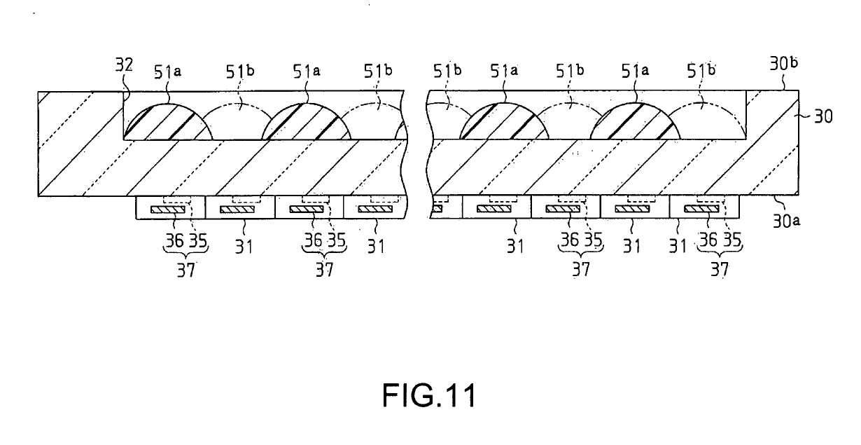

Next, a second embodiment of the invention will be explained with reference to FIGS. 8 to 11. Here, in the second embodiment differs from the first embodiment in that the shape of the micro lens and the manufacturing method are changed. Other than these, the second embodiment has the same structure of the first embodiment. Therefore, the shape of the micro lens and the manufacturing method will be minutely explained below. FIGS. 8 to 10 are a plan view of the exposure head 20 seen from the surface 30a for forming a light-emitting element, a plan view of the exposure head 20 seen from the surface 30b for taking out light, and a front sectional-view of the exposure head 20. FIG. 11 shows a process of the exposure head 20.

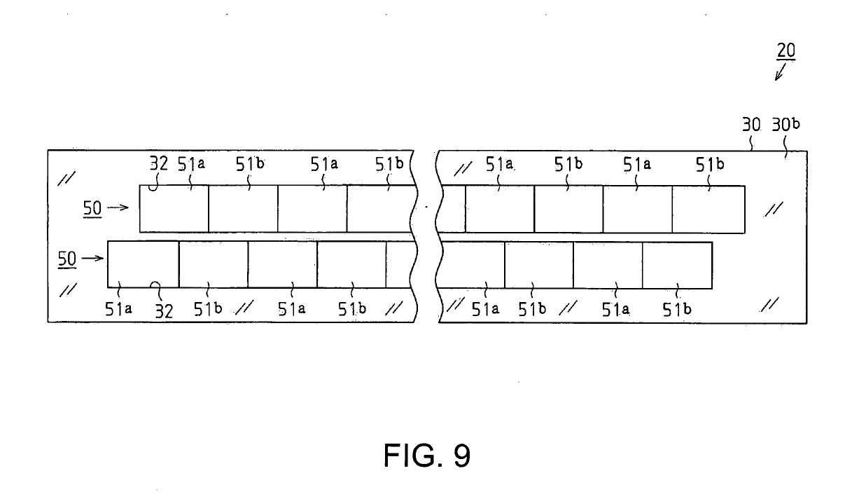

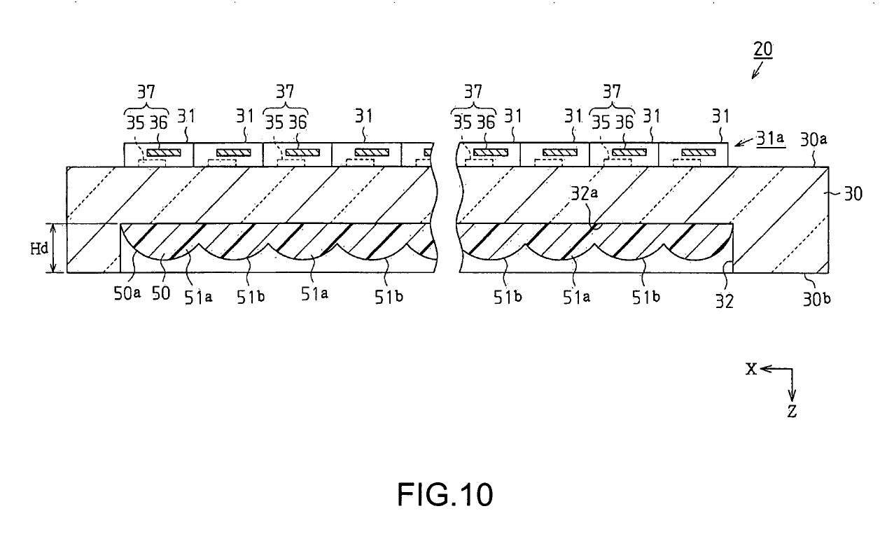

As shown in FIGS. 9 and 10, a micro lens 50 is formed on the groove bottom 32a of the groove 32. The micro lens 50 is a half-cylindrical group convex lens (lenticular lens), which is sufficiently transparent to the wavelength of light emitted from the organic EL layer Oe, and has the light-emitting surface 50a as an optical surface in the direction perpendicular to FIG. 10 (in the sub scanning direction Y: refer to FIG. 8). The micro lens 50 is formed along the longitudinal direction (main scanning direction X) of the groove 32 as shown in FIG. 10. In the micro lens 50, half-cylindrical convex lenses (a first lens 51a and a second lens 51b) are located so as to oppose to each light-emitting element 36.

In the embodiment, the first lens 51a is defined as the odd-numbered half-cylindrical convex lens, while the second lens 51b is defined as the even-numbered half-cylindrical convex lens, from the left end part of the groove 32 in FIG. 10. The first lens 51a and the second lens 51b are formed so that each curvature radius is larger than the inner radius of the light-emitting element 36 (organic EL layer Oe), i.e. the adjustment radius R. The micro lens 50 forms an image from the light-emitting surface 50a by reflecting power corresponding to its curvature radius.

Then, the micro lens 50 having a half-cylindrical shape converges light emitted from the light-emitting element 36 by reflecting light irradiated onto the surface perpendicular to the sub scanning direction Y. On the other hand, the micro lens 50 emits light irradiated onto the surface perpendicular to the main scanning direction X without converging (utilizing) the light.

Further, the micro lens 50 is formed within the groove 32, making the emitting surface 50a being near to the light-emitting element 36 side from the surface 30b for taking out light by the near distance Hd. Hence, the micro lens 50 increases the efficiency of using light irradiated onto the surface perpendicular to the sub scanning direction Y, compensating the loss of using light irradiated onto the surface perpendicular to the main scanning direction X (the direction for forming the groove 32). Therefore, it is possible to expand the tolerance for forming and allocating the micro lens 50 toward the sub scanning direction Y thereby, comparing to a case when a lens of which size is almost the same as that of the light-emitting element 36 is located at the position opposing to the light-emitting element 36.

Next, a method for manufacturing the exposure head 20 will be explained referring to FIG. 11. In the embodiment, since the exposure head 20 is manufactured with the liquid discharging device (liquid discharging head 45) described in the first embodiment, the description of the liquid discharging head 45 will be omitted in FIG. 11 in order to simplify the explanation.

First, a driving signal for forming the micro lens 50 is input to the liquid discharging head 45 (refer to FIG. 6). Likewise in the first embodiment, the substrate stage moves with the glass substrate 30 so as to position the left end part of the groove 32, which opposes to the first pixel column 31a, in FIG. 11, directly under the liquid discharging head 45 (the nozzle N). Upon positioning the left end part of the groove 32 directly under the nozzle N, the groove 32 (the glass substrate 30) is moved in the arrow direction Sa by the substrate stage. When the center position of each light-emitting element 36 (organic EL layer Oe: refer to FIG. 4) reaches at the position directly under the nozzle N, the liquid discharging head 45 oscillates in the direction perpendicular to FIG. 11 by the groove width of the groove 32, discharging the micro droplet Ds (refer to FIG. 6) to the position, which is located in the groove 32, opposing to the light-emitting element 36 at the odd-numbered position from the left end side of the groove 36. As a result, the half-cylindrical shape droplet having the outer circumferential surface in the direction perpendicular to FIG. 11 (in the sub scanning direction Y) is formed with a predetermined pitch, which is twice of the arranging pitch of the light-emitting element 36. Here, the curvature radius of the droplet is nearly equal to the curvature radius of the second lens 51b.

After providing the half-cylindrical shape droplet to each of the grooves 32 along its longitudinal direction, ultraviolet rays are irradiated to the grooves 32 so as to cure the droplet. As a result, the second lens 51b is formed that has a half-cylindrical shape whose outer circumferential surface is along the direction perpendicular to FIG. 11 (the sub scanning direction Y).

After forming the second lens 51b, the liquid discharging head 45 is operated again so as to discharge the micro droplet Ds between the second lenses 51b on the groove bottom 32a. In this time, the discharged micro droplet Ds is agglomerated by its surface tension to show a curved surface (chain double dashed line in FIG. 11) corresponding to the light-emitting surface 50a of the first lens 51a since the second lens 51b is cured by radiating ultraviolet rays. Then, ultraviolet rays are irradiated again into the groove 32 to cure the resin Pu, forming the micro lens 50 in which the first lens 51a and the second lens 51b are alternately arranged. Likewise, the micro lens 50 is formed in the groove 32 opposing to the second pixel column 31b.

Next, effects of the second embodiment will be described below.

(1) In the embodiment, the groove 32 is formed on the surface 30b for taking out light of the glass substrate 30 and the micro lens having a lenticular shape is formed along the arranging direction of the light-emitting element 36 (the main scanning direction X) in the groove 32. Therefore, it is possible to expand the tolerance for forming and allocating the micro lens 50 toward the sub scanning direction Y thereby, comparing to a case when a lens of which size is almost the same as that of the light-emitting element 36 is located at the position opposing to the light-emitting element 36. As a result, the productivity of the micro lens 40 and thus the productivity of the exposure head 20 and the printer 10 can be improved.

(2) In addition, the micro lens 50 (the light-emitting surface 50a) can be placed adjacent to the light-emitting element 36 by the depth of the groove 32 (the near distance Hd). Hence, the micro lens 50 can increase the efficiency of using light irradiated onto the surface perpendicular to the sub scanning direction Y, compensating the loss of using light irradiated onto the surface perpendicular to the main scanning direction X. Consequently, the productivity of the micro lens 50 and thus the productivity of the exposure head 20 and the printer 10 can be improved while maintaining the efficiency of using light emitted from the light-emitting element 36.

(3) In the embodiment, the droplet having a half-cylindrical shape is formed in the groove 32 and then the droplet is cured by irradiating ultraviolet rays to form the first lens 51a. Subsequently, the resin Pu is discharged between the first lenses 51a so as to form the second lens 51b. As a result, the micro lens 50 having a lenticular shape can be formed without the resin Pu nonuniformly combined.

The above-mentioned embodiments may be changed as the followings.

In the embodiment, the transparent substrate is embodied as the glass substrate 30. However, a plastic substrate such as polyimide resin or the like may be used in addition to the glass substrate. Any transparent substrates transmitting light emitted from the organic EL layer Oe may be used.

In the embodiment, the groove 32 is formed by sandblasting. However, laser machining with eximer laser or femtosecond laser or the like may be used in addition to the sandblasting. Any methods may be employed as long as the groove 36 can be formed at the position opposing to the emitting element 36.

In the embodiment, the mask agent Mk for sandblasting is removed after forming the groove 32. Alternatively, the mask agent Mk may remain on the surface 30b for taking out light without removing it.

The curvature radius and refractive power of the micro lenses 40 and 50 in the embodiment may satisfy the condition in which the light emitted from the organic EL layer Oe is converged so as to form an exposed spot having a desired size on the surface 30b for taking out light.

In the embodiment, the inner circumferential surface of the groove 32 is made to exhibit liquid repellency. However, the groove bottom 32a may exhibit lyophilicity against the liquid to form the micro lenses 40 and 50. Accordingly, the adhesiveness between the liquid discharged in the groove 32 and the groove bottom 32a, i.e. the adhesiveness between the glass substrate 30 and the micro lenses 40 and 50 can be improved.

In the embodiment, the micro lenses 40 and 50 are formed after forming the pixel element 37. However, the micro lenses 40 and 50 may be formed before forming the pixel element 37.

In the embodiment, the micro lenses 40 and 50 are embodied as the convex lens. However, they may be embodied as a concave lens.

In the embodiment, the micro lenses 40 and 50 are formed with the UV cured resin Pu. However, they may be formed with thermosetting resins, etc.

In the embodiment, the distance between the top of the light-emitting surface 40a and the photo sensitive layer 16a becomes the focal point distance Hf on image side so that the light emitted from the organic EL layer Oe is converged on the photo sensitive layer 16a. However, the distance is not limited to be the focal point distance Hf on image side. For example, the distance may be the distance to obtain the same magnified image of the organic EL layer Oe.

In the embodiment, the micro lenses 40 and 50 are formed by the liquid discharging device. However, the micro lenses 40 and 50, which are formed by a replica method or the like, may be provided in the groove 32.

In the embodiment, each pixel element 37 is provided with one TFT 35 controlling the emission of the light-emitting element 36. The number of TFTs 35 is not limited to be one, each pixel element 37 may be provided with two or more TFTs 35. Alternatively, the TFT 35 may not be included in the glass substrate 30.

In the embodiment, the organic EL layer Oe is formed by the inkjet method. The method for forming the organic EL layer Oe is not limited to the inkjet method. The spin coat method, vacuum vapor deposition method, or the like may be exemplified.

In the first embodiment, the groove 32 is formed larger than the micro lens 40 in size when the groove 32 is viewed from the direction of the optical axis A. The groove 32 may be formed in the same size as the micro lens 40. Accordingly, the location of the micro lens 40 can be positioned by the inner circumferential surface of the groove 32.

In the embodiment, the electro-optical device is embodied as the exposure head 20. However, the electro-optical device is not limited to this. Examples may include backlights mounted in liquid crystal displays, or field effect devices (FEDs, SEDs or the like) that include electron-emitter element having a flat shape and utilize the light emitted from the fluorescent material caused by the electron emitted from the element.

1. A transparent substrate, comprising:
a micro lens, light entered a side of a light incident surface of the transparent substrate being emitted from the micro lens formed on a side of a light taking-out surface of the transparent substrate, the micro lens being provided in a groove concaved from the light taking-out surface, and the micro lens being provided with an optical surface continuing in one direction.

2. The transparent substrate according to claim 1, the one direction being a direction in which the groove is formed, and the micro lens being a half-cylindrical convex lens having the optical surface in the one direction.

3. The transparent substrate according to claim 1, the one direction being the direction in which the groove is formed, and the micro lens being a half-cylindrical convex group lens including the half-cylindrical convex lens having the optical surface perpendicular to the one direction, and the half-cylindrical convex lens being provided in the one direction.

4. An electro-optical device, comprising:
a micro lens; and
a transparent substrate, light emitted from a light-emitting element arranged in one direction on a light-emitting element forming surface of the transparent substrate being emitted from the micro lens formed on a side of a light taking-out surface of the transparent substrate, the light taking-out surface opposing to the light-emitting element forming surface, the micro lens being provided in a groove concaved from the light taking-out surface, the micro lens having an optical surface opposing to the light-emitting element and the optical surface continuing in one direction.

5. The electro-optical device according to claim 4, the light-emitting element being an electroluminescent element including:
a transparent electrode formed on a side of the light taking-out surface;
a backside electrode formed so as to oppose to the transparent electrode; and
a light-emitting layer formed between the transparent electrode and the backside electrode.

6. The electro-optical device according to claim 5, the light-emitting layer being formed with an organic material, and the electroluminescent element being an organicelectro luminescent element.

7. The electro-optical device according to claim 4, the one direction being a direction in which the groove is formed, and the micro lens being a half-cylindrical convex lens having the optical surface in the one direction.

8. The electro-optical device according to claim 4, the one direction being a direction in which the groove is formed, and the micro lens being a half-cylindrical convex group lens including the half-cylindrical convex lens having the optical surface perpendicular to the one direction, and the half-cylindrical convex lens being provided in the one direction.

9. An image forming device, comprising:
a charging unit charging an outer circumferential surface of an image carrier;
an exposure unit exposing the charged outer circumferential surface of the image carrier so as to form a latent image;
a development unit developing a developed image by supplying a colored particle to the latent image; and
a transfer unit transferring the developed image to a transfer medium, the exposure unit being provided with the electro-optical device according to claim 4.

10. A method for manufacturing an electro-optical device, comprising:
forming a groove to a light taking-out surface of a transparent substrate;
forming a plurality of light-emitting elements at a position opposing to the groove, the position being located on a light-emitting element forming surface of the transparent substrate, the light-emitting element forming surface opposing to the light taking-out surface;
discharging a liquid in the groove from a liquid discharging device; and
solidifying the liquid so as to form a micro lens at a position opposing to the light-emitting element, the micro lens having an optical surface continuing in one direction.

11. The method for manufacturing an electro-optical device according to claim 10, the micro lens being a half-cylindrical lens having the optical surface, the optical surface being formed by forming a plurality of first droplets spaced apart each other in a forming direction in the groove, the first droplets being discharged by the liquid discharging device, and then by combining each of the first droplets with a second droplet discharged between the first droplets.

12. The method for manufacturing an electro-optical device according to claim 10, the micro lens being a half-cylindrical group convex lens, the half-cylindrical group convex lens being formed by forming a plurality of half-cylindrical convex lenses so as to be spaced apart each other, the half-cylindrical convex lenses having the optical surface in a direction perpendicular to a direction in which the groove is formed, with a liquid discharged in the groove by the liquid discharging device, and then by discharging the liquid again between the half-cylindrical convex lenses.
